(19) United States
(12) Patent Application Publication
(10) Pub. No.: US 2024/0232774 A1
(43) Pub. Date: Jul. 11, 2024

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Shodai SUZUKI, Tokyo (JP); Tsuneo OKAJIMA, Tokyo (JP); Satoshi WATANABE, Tokyo (JP); Ryohei IKEYA, Tokyo (JP); Kenji KONDO, Tokyo (JP)

(73) Assignee: NEC Corporation, Minato-ku, Tokyo (JP)

(21) Appl. No.: 18/561,970

(22) PCT Filed: May 27, 2021
(86) PCT No.: PCT/JP2021/020114

§ 371 Date: Nov. 17, 2023

(51) Int. Cl. G06Q 10/0639

(52) U.S. Cl. CPC G06Q 10/0639

(57) ABSTRACT

In order to accurately estimate a characteristic of a user, the characteristic causing a change in action of the user, an information processing apparatus (10) includes: an acquisition section (11) that acquires history information including information indicative of a history of a first action of a user and one or both of information indicative of a history of a second action of the user, the second action being different from the first action, and information indicative of a history of an environment around the user; a detection section (12) that detects a change in the first action with reference to the history information; and an estimation section (13) that estimates, with reference to the history information, a characteristic of the user, the characteristic causing the change.

### TECHNICAL FIELD

The present invention relates to a technique for carrying out a process that is in accordance with an action of a user.

### BACKGROUND ART

Proposed is a technique for carrying out a process that is in accordance with an action of a user. For example, Patent Literature 1 discloses an information processing apparatus including: a motivational change estimating means that estimates a motivational change of a user on the basis of (i) a change in action indicator (e.g., the amount of electricity used) which is an indicator indicative of an action state of the user for a promotion target action (e.g., power saving action) to be subjected to sales promotion and (ii) a change in typical action in a motivational type of the user (e.g., a type of the user who is motivated by monetary benefits, a type of the user who feels tired, or the like) and that outputs the estimated motivational change as an estimation result; and an information collection means that carries out an information collection process which is based on the estimation result.

### CITATION LIST

### Patent Literature

Patent Literature 1
Japanese Patent Application Publication Tokukai No. 2014-109936

### SUMMARY OF INVENTION

### Technical Problem

The technique disclosed in Patent Literature 1 is based on the premise that the motivational type used to estimate the motivational change of the user is determined, at the time of new registration of the user, by, for example, a questionnaire or a declaration by the user. Such a technique makes it impossible to estimate the motivational type itself. In a case where a characteristic of a user, such as a motivational type can be estimated as a cause of a change in action of the user, a process that is in accordance with the action of the user can be carried out more accurately.

An example aspect of the present invention has been made in view of the above problems, and an example object thereof is to provide a technique for accurately estimating a characteristic of a user, the characteristic causing a change in action of the user.

### Solution to Problem

An information processing apparatus according to an example aspect of the present includes: an acquisition means that acquires information indicative of a history of a first action of a user and one or both of information indicative of a history of a second action of the user, the second action being different from the first action, and information indicative of a history of an environment around the user; a detection means that detects a change in the first action with reference to the information indicative of the history of the first action; and an estimation means that estimates, with reference to one or both of the information indicative of the history of the second action and the information indicative of the history of the environment, a characteristic of the user, the characteristic causing the change.

An information processing method according to an example aspect of the present invention includes: (a) acquiring information indicative of a history of a first action of a user and one or both of information indicative of a history of a second action of the user, the second action being different from the first action, and information indicative of a history of an environment around the user; (b) detecting a change in the first action with reference to the information indicative of the history of the first action; and (c) estimating, with reference to one or both of the information indicative of the history of the second action and the information indicative of the history of the environment, a characteristic of the user, the characteristic causing the change, (a) to (c) each being carried out by the information processing apparatus.

A program according to an example aspect of the present invention is a program for causing a computer to function as an information processing apparatus, the program causing the computer to function as: an acquisition means that acquires information indicative of a history of a first action of a user and one or both of information indicative of a history of a second action of the user, the second action being different from the first action, and information indicative of a history of an environment around the user; a detection means that detects a change in the first action with reference to the information indicative of the history of the first action; and an estimation means that estimates, with reference to one or both of the information indicative of the history of the second action and the information indicative of the history of the environment, a characteristic of the user, the characteristic causing the change.

### Advantageous Effects of Invention

An aspect of the present invention makes it possible to accurately estimate a characteristic of a user, the characteristic causing a change in action of the user.

### BRIEF DESCRIPTION OF DRAWINGS

FIG. 1 is a block diagram of a configuration of an information processing apparatus according to a first example embodiment of the present invention.

FIG. 2 is a flowchart showing a flow of an information processing method according to the first example embodiment of the present invention.

FIG. 3 is a diagram schematically illustrating a configuration of a recommendation information providing system according to a second example embodiment of the present invention.

FIG. 4 is a diagram illustrating a specific example of purchase history information according to the second example embodiment of the present invention.

FIG. 5 is a flowchart showing a flow of a recommendation information providing method according to the second example embodiment of the present invention.

FIG. 6 is a diagram illustrating a specific example of a movement path of a user according to the second example embodiment of the present invention.

FIG. 7 is a diagram illustrating a specific example of environment history information according to the second example embodiment of the present invention.

FIG. 8 is a flowchart showing a flow of a second recommendation information providing method according to a third example embodiment of the present invention.

FIG. 9 is a diagram schematically illustrating a configuration of a recommendation information providing system according to a fourth example embodiment of the present invention.

FIG. 10 is a flowchart showing a flow of a third recommendation information providing method according to the fourth example embodiment of the present invention.

FIG. 11 is a block diagram illustrating a configuration of a computer functioning as, for example, each of information processing apparatuses according to the first to fourth example embodiments of the present invention.

### EXAMPLE EMBODIMENTS

### First Example Embodiment

The following description will discuss a first example embodiment of the present invention in detail with reference to the drawings. The present example embodiment is an embodiment serving as a basis for example embodiments described later.

### Configuration of Information Processing Apparatus

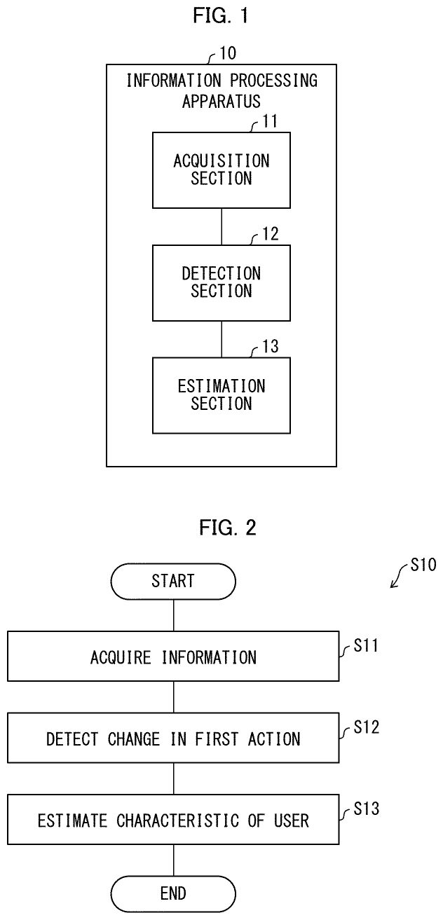

The following description will discuss a configuration of an information processing apparatus 10 according to the present example embodiment with reference to FIG. 1. FIG. 1 is a block diagram illustrating the configuration of the information processing apparatus 10. The information processing apparatus 10 specifies a change in action of a user and estimates a characteristic of the user, the characteristic causing the specified change. The information processing apparatus 10 includes an acquisition section 11, a detection section 12, and an estimation section 13. The acquisition section 11 is an example configuration that achieves an acquisition means recited in the claims. The detection section 12 is an example configuration that achieves a detection means recited in the claims. The estimation section 13 is an example configuration that achieves a generation means recited in the claims.

The acquisition section 11 acquires information indicative of a history of a first action of the user and one or both of information indicative of a history of a second action of the user and information indicative of a history of an environment around the user. The detection section 12 detects a change in the first action with reference to the information indicative of the history of the first action. The estimation section 13 estimates, with reference to one or both of the information indicative of the history of the second action and the information indicative of the history of the environment, a characteristic of the user, the characteristic causing the change.

### First Action of User

Examples of the first action of the user include movement of the user. Examples of the first action of the user also include purchase of a product by the user, the user visiting a facility such as a store, the user receiving provision of a service at a facility such as a gym, a museum, or a hospital, the user wearing sunglasses, and the user being under a parasol. The first action of the user is not limited to the above-listed actions and may alternatively be another action.

### Second Action of User

The second action of the user is an action of the user, the action being different from the first action. Examples of the second action of the user include purchase of a product by the user. Examples of the second action of the user also include movement of the user, the user visiting a facility such as a store, the user receiving provision of a service at a facility such as a gym, a museum, or a hospital, the user wearing sunglasses, and the user being under a parasol. The second action of the user is not limited to the above-listed actions and may alternatively be another action that is different from the first action.

### Environment Around User

Examples of the environment around the user include air temperature, room temperature, wind force, weather, sunshine, and pollen around the user. Such environments are subjected to measurement by, for example, sensors provided at respective arbitrary points.

### Characteristic of User

The characteristic of the user is a feature of the user, the feature causing a change in the first action of the user. The characteristic of the user refers to, for example, a feature such that the user likes a predetermined event. Specific examples of such a characteristic include a feature such that the user likes a sunny place and a feature such that the user likes a lively place. For example, the user who likes a sunny place tends to select a sunny path while avoiding a less sunny path. The user who likes a lively place tends to select a crowded place while avoiding a less crowded place.

Alternatively, the characteristic of the user refers to, for example, a feature such that the user dislikes (wishes to avoid) a predetermined event. Specific examples of such a characteristic include a feature such that the user dislikes getting suntanned, a feature such that the user has a pollen allergy, a feature such that the user dislikes a crowd, and a feature such that the user avoids the outdoors under rainy weather. For example, the user who dislikes getting suntanned tends to select a shady path while avoiding a sunny path. Furthermore, for example, the user who dislikes a crowd tends to avoid a crowded place. Moreover, for example, the user who has a pollen allergy tends to avoid a place with a high pollen count. The characteristic of the user is not limited to the above-listed characteristics and may alternatively be another characteristic.

### <Flow of Information Processing Method>

The following description will discuss a flow of an information processing method S10 according to the present example embodiment with reference to FIG. 2. FIG. 2 is a flowchart showing the flow of the information processing method S10.

### (Step S11)

In a step S11 (acquisition process), the acquisition section 11 acquires information indicative of a history of a first action of the user and one or both of information indicative of a history of a second action of the user and information indicative of a history of an environment around the user.

For example, the acquisition section 11 may acquire, from an apparatus connected via a network, information indicative of a history of a first action of the user and one or both of information indicative of a history of a second action of the user and information indicative of a history of an environment around the user. Alternatively, for example, the acquisition section 11 may acquire, from an input apparatus or by reading from a memory, information indicative of a history of a first action of the user and one or both of information indicative of a history of a second action of the user and information indicative of a history of an environment around the user. The acquisition section 11 may acquire the information pertaining to a single user or may acquire the information pertaining to a plurality of users.

For example, in a case where the first action includes movement, the user may be a user who possesses a user terminal having a positioning function. In this case, the acquisition section 11 acquires information indicative of a history of position information of the user as the information indicative of the history of the first action from a server that acquires the position information from the user terminal at any time as needed, and stores the position information.

For example, in a case where the second action includes purchase of a product, the user may be a user who has performed membership registration for purchase of the product. In this case, the acquisition section 11 acquires information indicative of a history of purchase information as the information indicative of the history of the second action from a server that records information pertaining to purchase of a product by a member.

For example, the acquisition section 11 acquires, from a server that collects measured values from the above-described sensors provided at respective places and that records the measured values, the information indicative of the history of the environment around the user. Specifically, in this case, the information indicative of the history of the environment around the user is a history of measured values measured, by a sensor provided around a location at which the user was present in the past, at or near a point in time at which the user was present.

### (Step S12)

In a step S12 (detection process), the detection section 12 detects a change in the first action with reference to the information indicative of the history of the first action. For example, the detection section 12 detects a change in region in which the user stays or a change in movement path.

For example, in a case where the information indicative of the history of the position information of the user is acquired as the information indicative of the history of the first action, the detection section 12 repeatedly determines whether the most recent position information of the user is included in a predetermined region. Thus, the detection section 12 detects, as the change in region in which the user stays, a change from a state in which inclusion of the position information of the user in the predetermined region continues for not less than a certain period of time to a state in which non-inclusion of the position information of the user in the predetermined region continues for not less than a certain period of time.

Furthermore, for example, in a case where the information indicative of the history of the position information of the user is acquired as the information indicative of the history of the first action, the detection section 12 specifies, on the basis of a movement path along which the user moved from a predetermined point A to a point B in the past, a regular route that is most used by the user. Moreover, in a case where a movement path along which the user most recently moved from the point A to the point B is an irregular route that is different from the regular route, the detection section 12 detects, as a change in movement path, that the user moved by the irregular route.

### (Step S13)

In a step S13 (estimation process), the estimation section 13 estimates, with reference to one or both of the information indicative of the history of the second action and the information indicative of the history of the environment, a characteristic of the user, the characteristic causing the change. For example, the estimation section 13 refers to one or both of the information indicative of the history of the second action and the information indicative of the history of the environment before and after the change in the first action.

For example, in a case where information indicative of a history of purchase of consumption by the user is acquired as the information indicative of the history of the second action, the detection section 12 specifies at least one product purchased by the user in a certain period including a point in time at which the change was detected. The detection section 12 also estimates, as the characteristic of the user, the characteristic causing the change, a characteristic of the user, the characteristic being associated with each of the at least one specified product. It is assumed in this case that a remarkable characteristic of the user who purchases a product is associated with the product in advance.

In a case where information indicative of a history of weather around the user is acquired as the information indicative of the history of the environment around the user, the detection section 12 specifies information indicative of weather around the regular route at a time when the regular route is used, the time being before the change in the first action. The detection section 12 also specifies information indicative of weather around the irregular route at a time when the irregular route is used, the time being after the change in the first action. The detection section 12 also compares these specified pieces of information indicative of weather to estimate a characteristic of the user as the characteristic of the user, the characteristic causing the change.

### <Effect of the Present Example Embodiment>

As described above, a configuration is employed such that in the information processing apparatus 10 according to the present example embodiment, a change in a first action of a user is detected with reference to information indicative of a history of the first action, and a characteristic of the user, the characteristic causing the detected change, is estimated with reference to one or both of information indicative of a second action of the user and information indicative of a history of an environment around the user. Thus, the information processing apparatus 10 according to the present example embodiment makes it possible to accurately estimate a characteristic of a user, the characteristic causing a change in action of the user.

### Second Example Embodiment

The following description will discuss a second example embodiment of the present invention in detail with reference to the drawings. Note that members having functions identical to those of the respective members described in the first example embodiment are given respective identical reference numerals, and a description of those members is not repeated.

### <Configuration of System>

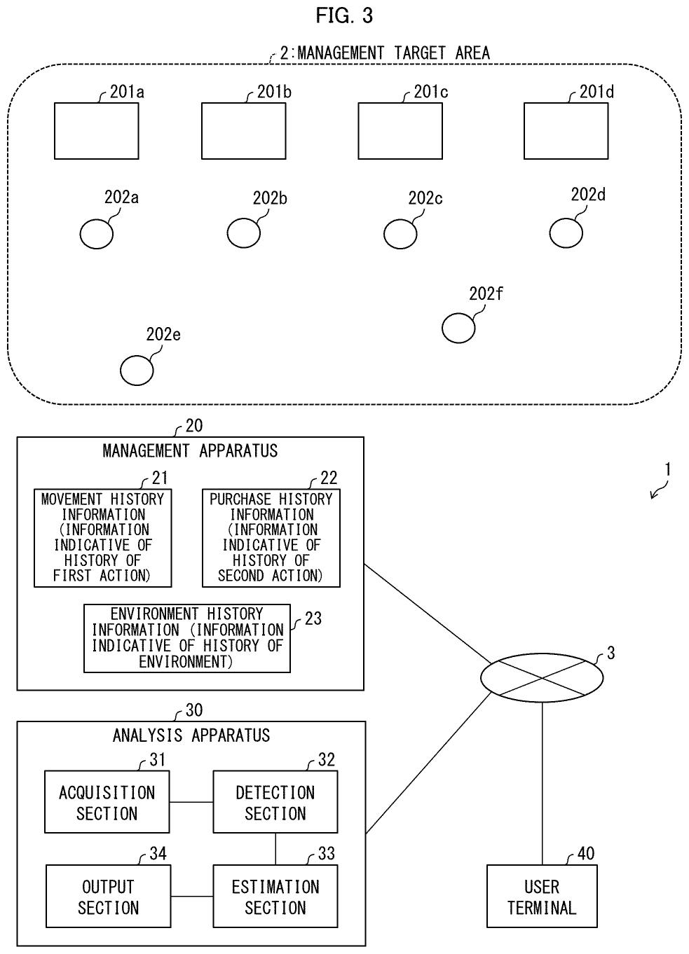

FIG. 3 is a diagram schematically illustrating a configuration of a recommendation information providing system 1 according to the second example embodiment of the present invention. The recommendation information providing system 1 is a system that estimates a characteristic of an end user, the characteristic causing a change in movement of the end user in a management target area 2, and that provides recommendation information which is in accordance with the estimated characteristic of the end user. In the following description, for convenience of description, the end user of the recommendation information providing system 1 is also simply referred to as “user”.

### (Management Target Area)

The management target area 2 is a management target area of the recommendation information providing system 1 and is, for example, an area of a commercial complex. In FIG. 3, the management target area 2 includes a plurality of facilities 201a to 201d and a region around those facilities. The plurality of facilities 201a to 201d are facilities that are used by end users of the recommendation information providing system 1. Examples of such facilities include a hospital, an office building, a store, a pharmacy, a gym, an art museum, a museum, a gymnasium, a commercial facility, and a tenant of the commercial complex. The example of FIG. 3 illustrates the four facilities 201a to 201d. Note, however, that the number of facilities included in the management target area 2 is not limited to four and may be more or less than four.

A plurality of sensors 202a to 202f are provided in the management target area 2. The plurality of sensors 202a to 202f are sensors for collecting information pertaining to an environment of the management target area 2. The plurality of sensors 202a to 202f are, for example, sensors for measuring air temperature, humidity, or wind force, or sensors for observing weather or sunshine. The plurality of sensors 202a to 202f may be, for example, sensors for observing a state in which pollen spreads, or cameras for photographing the management target area 2. In the following description, the plurality of sensors 202a to 202f that do not need to be distinguished from each other are each referred to as “sensor 202”. The example of FIG. 3 illustrates eight sensors 202a to 202f. Note, however, that the number of sensors 202 included in the management target area 2 is not limited to eight and may be more or less than eight.

Each of the plurality of sensors 202 is associated with at least one environmental factor. At least one of the plurality of sensors 202 is, for example, a sensor that measures illuminance. The sensor 202 that measures illuminance generates, for example, data “environmental factor: “sunshine”, measured value:**, position (latitude, longitude), time (yyyy/mm/dd, hh/mm)”, and transmits the generated data to a management apparatus 20.

The recommendation information providing system 1 includes, as illustrated in FIG. 3, the management apparatus 20, an analysis apparatus 30, and a user terminal 40. The management apparatus 20 and the analysis apparatus 30 may be provided in the management target area 2 or may be provided in a place different from the management target area 2. The management apparatus 20 and the analysis apparatus 30 are communicatively connected with the sensors 202 and the user terminal 40 via a communication network 3. The communication network 3 is, for example, a wired local area network (LAN), a wireless LAN, the Internet, or a combination thereof.

### (Management Apparatus 20)

The management apparatus 20 is an apparatus that accumulates information indicative of a history of a first action of a user, information indicative of a history of a second action of the user, and information indicative of a history of an environment around the user. In the present example embodiment, the first action of the user is movement of the user, and the second action of the user is purchase of a product by the user. The management apparatus 20 includes a storage apparatus. The storage apparatus of the management apparatus 20 stores movement history information, purchase history information, and environment history information.

### (Movement History Information)

The movement history information is information indicative of a history of movement of the user. The movement history information is an example of information indicative of a history of a first action, the information being recited in the claims. The management apparatus 20 acquires information indicative of a position of the user from the user terminal 40 that is possessed by the user, and stores, in the storage apparatus, the movement history information obtained by attaching time information to the acquired information.

The information indicative of the position of the user may be, for example, information indicative of a position that is specified on the basis of a signal from a global positioning system (GPS), or may be information indicative of a position that is specified on the basis of a signal transmitted by a beacon. In a case where the information indicative of the position of the user is information that is specified on the basis of a signal from a beacon, at least one beacon transmitting apparatus is provided in the management target area 2, and the user terminal 40 receives a signal transmitted by the beacon transmitting apparatus, so that the position is specified on the basis of the received signal.

### (Purchase History Information)

The purchase history information is information indicative of a history of purchase of a product by the user. The purchase history information is an example of information indicative of a history of a second action, the information being recited in the claims. The purchase history information is, for example, information indicative of a purchase history for each user, the information being managed by a payment system of each store. The management apparatus 20 may collect, for example, the purchase history information of the user by collecting payment information for each store via a payment platform used by each store (each tenant). Alternatively, for example, the management apparatus 20 may acquire, from another apparatus or another system, the purchase history information managed for each user.

### (Environment History Information)

The environment history information is information indicative of the history of the environment around the user and is one or both of information indicative of results of measurement by the sensors 202 and open data provided by, for example, a weather service. The management apparatus 20 associates, with the position information and the time information, information indicative of the results of measurement by the sensors 202 or data provided by, for example, a weather service, and accumulates, in the storage apparatus of the management apparatus 20, the information or the data that is associated with the position information and the time information.

### (Analysis Apparatus)

The analysis apparatus is an apparatus that outputs the recommendation information which is in accordance with a characteristic of the user, the characteristic causing a change in action of the user. The analysis apparatus is an example of an information processing apparatus recited in the claims.

### (User Terminal)

The user terminal 40 is a terminal that is used by the user, and is, for example, a personal computer, a tablet terminal, or a smartphone. The user terminal 40 is, for example, a terminal carried by the user. The user terminal 40 includes, for example, a touch panel in which a display panel functioning as an output device and a touch sensor functioning as an input device are integrated. FIG. 3 illustrates a single user terminal 40. Note, however, that the recommendation information providing system 1 may include a plurality of user terminals 40.

### <Configuration of Analysis Apparatus>

The following description will discuss a configuration of an analysis apparatus 30 according to the present example embodiment with reference to FIG. 3. The analysis apparatus 30 includes an acquisition section 31, a detection section 32, an estimation section 33, and an output section 34. The acquisition section 31 is an example configuration that achieves the acquisition means recited in the claims. The detection section 32 is an example configuration that achieves the detection means recited in the claims. The estimation section 33 is an example configuration that achieves the estimation means recited in the claims. The output section 34 is an example configuration that achieves an output means recited in the claims.

The acquisition section 31 acquires the movement history information, the purchase history information, and the environment history information. The detection section 32 detects a change in the first action of the user with reference to the movement history information. In the present example embodiment, the detection section 32 detects a change in movement path of the user as the change in the first action of the user.

The estimation section 33 estimates, with reference to the purchase history information and the environment history information, a characteristic of the user, the characteristic causing the change in the first action of the user. The output section 34 outputs the recommendation information that is in accordance with the characteristic of the user.

### (Recommendation Information)

The recommendation information is information indicative of, for example, a matter or product that is recommended to the user, the information corresponding to the characteristic of the user. The recommendation information is, for example, information indicative of a movement path recommended to the user, a store in a commercial complex, or a product. More specifically, the recommendation information is, for example, information indicative of a movement path with a low pollen count or information indicative of a shady movement path. The recommendation information is, for example, information indicative of a store that sells a product effective for a pollen allergy or sun shading, or such a product itself.

### (Specific Example of Purchase History Information)

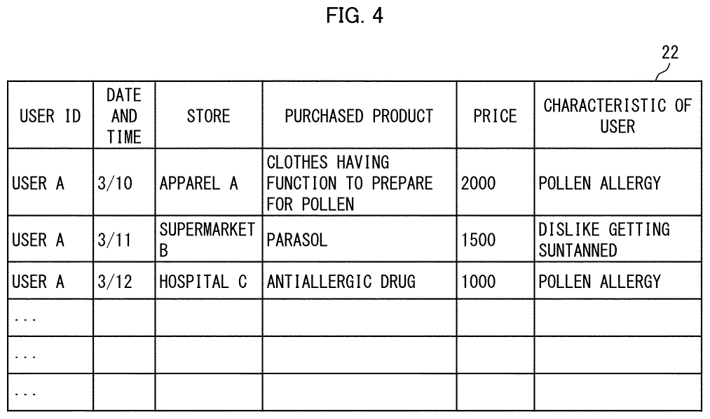

FIG. 4 is a diagram illustrating a specific example of the purchase history information according to the present example embodiment. In FIG. 4, the purchase history information includes the following items: “user ID”, “date and time”, “store”, “purchased product”, “price”, and “characteristic of user”. In the item “user ID” among these items, a user ID that is identification information for identifying a user is stored. A single user ID may be assigned to a single user, or a plurality of user IDs may be assigned to a single user. For example, in a case where a single user uses user IDs that differ from tenant to tenant, the management apparatus 20 may manage data for each user by associating those plurality of user IDs with each other.

In the item “date and time”, information indicative of the date and time when the user purchased a product is stored. In the item “store”, information indicative of a store at which the user purchased the product is stored. The information indicative of the store is, for example, a store name such as “apparel A”, “supermarket B”, or “hospital C”. In the item “purchased product”, information indicative of the product purchased by the user is stored. The information indicative of the product is, for example, a product name. Note that information indicative of a service provision of which was received by the user may be stored in the item “purchased product”.

In the item “price”, information indicative of the price of the product purchased by the user is stored. In the item “characteristic of user”, information indicative of a characteristic of the user, the characteristic corresponding to the product, is stored. In the present example embodiment, the product and the characteristic of the user are associated with each other in advance by, for example, a predetermined database. The management apparatus 20 stores, in the item “characteristic of user”, the characteristic of the user, the characteristic being associated with the product. The characteristic of the user, the characteristic being associated with the product, may be a characteristic of the user targeted by the product. In the present example embodiment, the characteristic of the user, the characteristic being associated with the product, indicates a tendency for the user to dislike (wish to avoid) a predetermined event. For example, a user characteristic “dislike getting suntanned” is associated with products such as a sunblock cream and a parasol. A user characteristic “pollen allergy” is associated with products such as a mask, outerwear having a function to prepare for pollen, eyedrops, and a pharmaceutical prescription.

### <Method for Collecting Movement History Information>

The following description will discuss a method in which the management apparatus 20 collects the movement history information of the user. The user moves in the management target area 2 while carrying the user terminal 40. The management apparatus 20 acquires information indicative of a position of the user terminal 40 from the user terminal 40 or another server apparatus, and accumulates, in the storage apparatus, the movement history information obtained by attaching the time information to the acquired information. The information indicative of the position is, for example, information that is based on a signal from GPS, the signal being received by the user terminal 40, or information that is based on a signal from a beacon. The management apparatus 20 may regularly collect the movement history information of the user, or may acquire position history information at a timing at which the user terminal 40 moves.

### <Method for Collecting Purchase History Information and Environment History Information>

The management apparatus 20 also collects the purchase history information and the environment history information of the user, and accumulates the purchase history information and the environment history information in the storage apparatus. For example, the management apparatus 20 acquires the purchase history information from another server apparatus connected via the communication network 3, and accumulates the purchase history information in the storage apparatus. Furthermore, for example, the management apparatus 20 acquires the environment history information from another server apparatus connected via the sensor 202 and the communication network 3, and accumulates the environment history information in the storage apparatus. The management apparatus 20 may acquire the purchase history information and the environment history information to each of which the time information is attached. The management apparatus 20 may attach the time information to each of the purchase history information and the environment history information that are received from another apparatus, and accumulate the purchase history information and the environment history information in the storage apparatus.

### <Flow of Recommendation Information Providing Method>

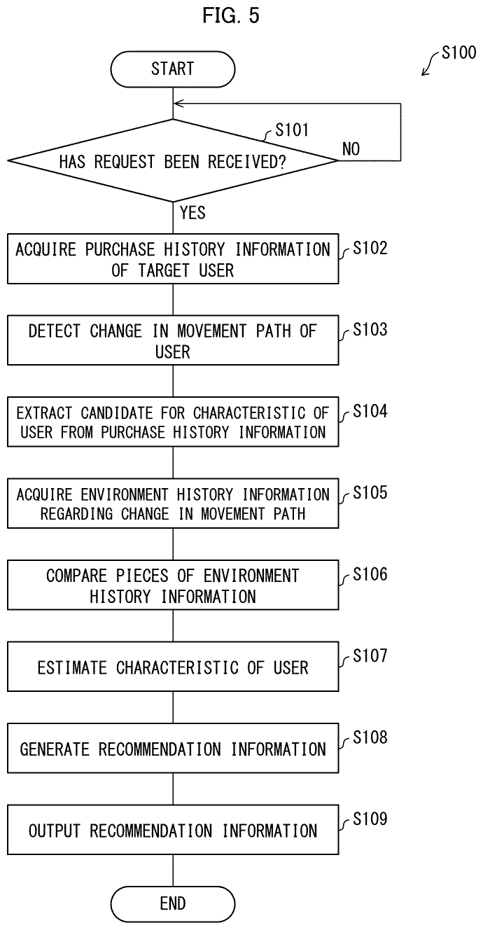

Next, the following description will discuss, with reference to the drawings, a recommendation information providing method S100 carried out by the analysis apparatus 30. FIG. 5 is a flowchart showing a flow of the recommendation information providing method S100 carried out by the analysis apparatus 30. Note that some of steps included in the recommendation information providing method S100 may be carried out in parallel or in a different order.

The user who wishes to receive the recommendation information operates the user terminal 40 and requests provision of the recommendation information. The user terminal 40 transmits a request for provision of the recommendation information to the analysis apparatus 30 in accordance with details of an operation carried out by the user. The request transmitted by the user terminal 40 includes a user ID that is identification information for identifying the user.

### (Step S101)

In a step S101, the acquisition section 31 of the analysis apparatus 30 waits until the request for provision of the recommendation information is received (NO in the step S101). Upon receiving the request for provision of the recommendation information (YES in the step S101), the acquisition section 31 proceeds to the process in a step S102.

### (Step S102)

In the step S102, the acquisition section 31 acquires, from the management apparatus 20, the purchase history information of the user who corresponds to the received request, i.e., who is a target to which the recommendation information is to be provided (hereinafter referred to as “provision target”).

### (Step S103)

In a step S103, the detection section 32 acquires, from the management apparatus 20, the movement history information of the user who is the provision target, and detects, on the basis of the acquired movement history information, the change in movement path of the user who is the provision target.

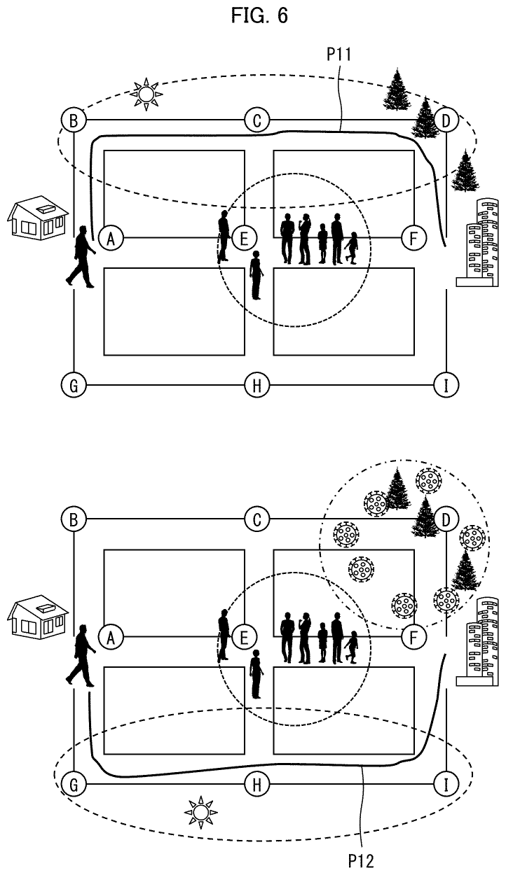

The following description will discuss, with reference to FIG. 6, a specific example of a method in which the detection section 32 detects the change in movement path. FIG. 6 is a diagram illustrating a specific example of the movement path of the user who is the provision target. In the example of FIG. 6, the user moves from a point A to a point F. There are a plurality of movement paths along which the user moves from the point A to the point F, and the user moves along different movement paths in accordance with the characteristic of the user at different times. For example, the user who has a pollen allergy moves while avoiding a point with a high pollen count in a season in which pollen spreads, or the user who dislikes getting suntanned selects a shady movement path depending on a time period.

In the example of FIG. 6, the detection section 32 specifies, on the basis of the movement history information of the user who is the provision target, a movement path P11 and a movement path P12 of the user who moves from the point A to the point F. The movement path P11 is a path along which the user moves in an order of the point A, a point B, a point C, a point D, and the point F. The movement path P12 is a path along which the user moves in an order of the point A, a point G, a point H, a point I, and the point F. The detection section 32 specifies, as a “regular route”, the movement path that is selected at a rate which is not less than a threshold, and specifies, as an “irregular route”, the movement path that is selected at a rate which is less than the threshold. In the present example embodiment, during the morning weekday hours, the user basically uses the movement path P11 but sometimes uses the movement path P12. That is, a frequency at which the user who is the provision target moves along the movement path P11 is higher than a frequency at which the user who is the provision target moves along the movement path P12. Thus, the detection section 32 specifies the movement path P11 as the “regular route” and specifies the movement path P12 as the “irregular route”.

In the example of FIG. 6, for example, in a case where the movement path of the user who is the provision target changes from the movement path P11 to the movement path P12, the detection section 32 detects a change in movement path.

### (Step S104)

In steps S104 to S107 of FIG. 5, the estimation section 33 estimates the characteristic of the user with reference to the purchase history information and the environment history information. In other words, in the present example embodiment, the estimation section 33 estimates the characteristic of the user with reference to the product purchased by the user.

First, in the step S104, the estimation section 33 extracts candidates for the characteristic of the user from the purchase history information. Specifically, the estimation section 33 extracts a characteristic of a user, the characteristic being included in the purchase history information of the user ID of the user who is the provision target. For example, in a case where the purchase history information is information details of which are illustrated in FIG. 4, and the user who is the provision target is a “user A”, the estimation section 33 extracts, as the candidates for the characteristic of the user, “dislike getting suntanned” and “pollen allergy”, which are two characteristics of the user, the two characteristics being associated, in the purchase history information, with products purchased by the “user A”.

More specifically, assume, for example, that in a predetermined period of time (e.g., the last one month) including a point in time when the movement path changed, the user A purchased, at an apparel store B11, clothes having a function to prepare for pollen, purchased a parasol at a supermarket B12, and purchased a prescription-based pharmaceutical product for a pollen allergy at a hospital B13. In this case, as a characteristic of the user, the characteristic being associated with a purchased product, two characteristics, which are “dislike getting suntanned” and “pollen allergy”, are extracted.

### (Step S105)

In the step S105, the acquisition section 31 acquires, from the management apparatus 20, the environment history information regarding the change in movement path of the user who is the provision target. The environment history information regarding the change in movement path include, for example, the environment history information collected in the movement path before the change, and the environment history information collected in the movement path after the change. For example, in the step S103, in a case where the detection section 32 detects that the movement path of the user who is the provision target has changed from the regular route to the irregular route, the acquisition section 31 acquires the environment history information collected in the regular route and the environment history information collected in the irregular route. Note here that the environment history information collected in the regular route is the environment history information collected on or near the regular route during one or both of a time in which the user A used the regular route and a time in which the user A used the irregular route. Note also that the environment history information collected in the irregular route is the environment history information collected on or near the irregular route during one or both of the time in which the user A used the regular route and the time in which the user A used the irregular route. Note that the time in which the regular route or the irregular route was used refers to a predetermined period including a point in time at which the regular route or the irregular route was used.

### (Step S106)

In the step S106, the estimation section 33 compares the environment history information before the change with the environment history information after the change.

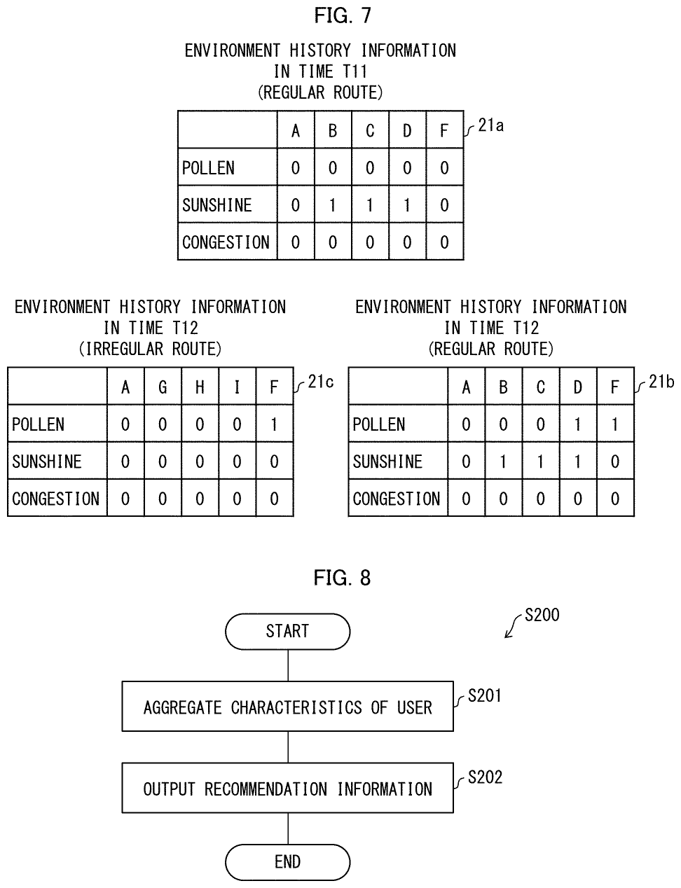

FIG. 7 is a diagram illustrating a specific example of pieces of the environment history information, the pieces being compared in the step S106. In FIG. 7, environment history information 21a is the environment history information in a time T11 that is before the change. Environment history information 21b and environment history information 21c are pieces of the environment history information in a time T12 that is after the change.

The environment history information 21a to the environment history information 21c are pieces of information, the pieces indicating, at points included in the regular route or the irregular route, measurement results for a plurality of environment factors, which are “pollen”, “sunshine”, and “congestion”. The environment history information 21a to the environment history information 21c include, for each of a plurality of points, items of “pollen”, “sunshine”, and “congestion”. For example, in each of the plurality of points, “1” is stored in the item of “pollen” in a case where a pollen count in a predetermined period is not less than a predetermined threshold, and “O” is stored in a case where the pollen count is less than the predetermined threshold. Furthermore, for example, in each of the plurality of points, “1” is stored in the item of “sunshine” in a case where sunshine duration in a predetermined period is not less than a threshold, and “O” is stored in a case where the sunshine duration is less than the threshold. Moreover, for example, in each of the plurality of points, “1” is stored in the item of “congestion” in a case where a degree of congestion in a predetermined period is not less than a threshold, and “O” is stored in a case where the degree of congestion is less than the threshold.

The environment history information 21a is information indicative of measurement results obtained, at each of the points A, B, C, D, and F, which are included in the regular route, in the time T11 that is before the change, for the plurality of environment factors, which are “pollen”, “sunshine”, and “congestion”. In the environment history information 21a, the item of “pollen” is “O” at all of the points A to F. Thus, in the time T11, pollen is not spread or spread in a low amount on the regular route. Furthermore, the item of “sunshine” is “1” at the points B, C, and D, and the item of “sunshine” is “0” at the other points. Thus, there is no shade or little shade at the points B, C, and D. Moreover, the item of “congestion” is “O” at all of the points A to F. Thus, the regular route is not congested in the time T11.

In contrast, the environment history information 21b is information indicative of measurement results obtained, at each of the points A, B, C, D, and F, which are included in the regular route, in the time T12 that is after the change, for the plurality of environment factors, which are “pollen”, “sunshine”, and “congestion”. A comparison between the environment history information 21a and the environment history information 21b shows that the item of “pollen” of the point D in the environment history information 21a is “0”, whereas the item of “pollen” of the environment history information 21b is “1”. That is, on the regular route, after the change in the first action of the user who is the provision target, a larger amount of pollen is scattered than before the change.

The environment history information 21c is information indicative of measurement results obtained, at each of the points A, G, H, I, and F, which are included in the irregular route, in the time T12 that is after the change, for the plurality of environment factors, which are “pollen”, “sunshine”, and “congestion”. In the environment history information 21c, among the points A, G, H, I, and F, the item of “pollen” of the point F is “1”, and the item of “pollen” of the other points is “0”.

Thus, in the time T12, pollen spreads at the point F. Furthermore, at all the points included in the irregular route, the item of “sunshine” is “0”, and thus there are many shades on the irregular route in the second time. Moreover, at all the points included in the irregular route, the item of “congestion” is “O”, and thus the irregular route is not congested in the time T12.

A comparison between the environment history information 21a and the environment history information 21c shows that before and after the change in the first action of the user, the measurement result for “pollen” has changed, and the measurement result for “sunshine” has changed.

### (Step S107)

In the step S107, the estimation section 33 estimates, on the basis of results of comparison in the step S106, at least one user characteristic from among candidates for the characteristic of the user, the candidates having been extracted in the step S104. In the present example embodiment, the estimation section 33 estimates, as the characteristic of the user, a tendency for the user to avoid an event that is avoidable by the change in the first action.

The following description will discuss, with reference to FIG. 7, a specific example of an estimation process carried out by the estimation section 33. In the example of FIG. 7, a comparison between the environment history information 21a and the environment history information 21b shows that in the environment history information 21b, the number of points at which the item of “pollen” is “1” is greater by 2 than the number in the environment history information 21a. Furthermore, a comparison between the environment history information 21a and the environment history information 21c shows that in the environment history information 21c, the number of points at which the item of “pollen” is “1” is greater by 1 than the number in the environment history information 21a and that in the environment history information 21c, the number of points at which the item of “sunshine” is “1” is smaller by 3 than the number in the environment history information 21a.

In the environment history information 21a and the environment history information 21c, the measurement results have changed for the items of “pollen” and “sunshine”. In contrast, in the environment history information 21a and the environment history information 21b, the measurement result for “sunshine” has not changed. Thus, the estimation section 33 determines that the environmental factor “sunshine” does not cause the change in the first action of the user. That is, the estimation section 33 estimates, on the basis of a result of comparison between the environment history information 21a and the environment history information 21b and a result of comparison between the environment history information 21a and the environment history information 21c, that the environmental factor causing the change in the first action of the user is “pollen”. The estimation section 33 estimates, on the basis of the above estimation result, that the characteristic of the user who is the provision target is “pollen allergy”.

The above-described example has discussed a case where the estimation section 33 estimates a single characteristic. However, in the step S107, the estimation section 33 may estimate a plurality of characteristics as the characteristic of the user who is the provision target. The estimation section 33 that estimates a plurality of characteristics may carry out weighting with respect to the plurality of characteristics. For example, with reference to the purchase history information of the user who is the provision target, the estimation section 33 may assign weights to the plurality of characteristics in descending order of number of corresponding products. For example, in a case where the details of the purchase history information of the user who is the provision target are as illustrated in FIG. 4, the number of products corresponding to the characteristic of “pollen allergy” is 2, and the number of products corresponding to the characteristic of “dislike getting suntanned” is 1. In this case, for example, the estimation section 33 sets a weighting factor of “pollen allergy” to “⅔” and sets a weighting factor of “dislike getting suntanned” to “⅓”.

### (Step S108)

In a step S108, the output section 34 generates the recommendation information that is in accordance with the characteristic of the user, the characteristic having been estimated by the estimation section 33 in the step S107. In a case where the estimation section 33 estimates a plurality of characteristics, the output section 34 generates the recommendation information for each of the plurality of characteristics estimated by the estimation section 33.

The recommendation information is, for example, information indicative of a movement path that is recommended to the user. In a case where the characteristic of the user, the characteristic having been estimated by the estimation section 33, is “pollen allergy”, the recommendation information is, for example, information indicative of a movement path with a low pollen count. In this case, for example, the output section 34 specifies a plurality of movement paths from an origin to a destination on the basis of information indicative of a past movement path of the user who is the provision target. The output section 34 also counts, from among the specified plurality of movement paths, the number of points which are included in each of the plurality of movement paths and at which the item of the environment factor “pollen” is “1”, and generates, as the recommendation information, information indicative of a movement path having the smallest number.

Note that instead of the output section 34 generating the recommendation information, the recommendation information and the characteristic of the user may be associated with each other in advance. In this case, the output section 34 carries out a process for reading, from a predetermined database, the recommendation information corresponding to the characteristic of the user, the characteristic having been estimated by the estimation section 33 in the step S107.

The recommendation information is not limited to the above-described information and may be other information. For example, the output section 34 may use, as the recommendation information, information indicative of clothes having a function to prepare for a pollen allergy, a parasol, and an antiallergic drug. Alternatively, for example, the output section 34 may use, as the recommendation information, information regarding a store selling an antiallergic drug (a store name, a location of the store, etc.).

### (Step S109)

In a step S109, the output section 34 outputs, to a terminal that is used by the user, the recommendation information that is in accordance with the characteristic of the user. For example, the output section 34 outputs the recommendation information to the user terminal 40, from which a request for provision of the recommendation information is transmitted. In a case where the estimation section 33 estimates a plurality of characteristics, the output section 34 outputs, in accordance with weighting, the recommendation information corresponding to each of the plurality of characteristics.

The user terminal 40 receives the recommendation information from the analysis apparatus 30 and presents the received recommendation information to the user by, for example, displaying the recommendation information on a touch panel. For example, the user terminal 40 displays an image (such as a map) representing a recommended movement path on a display apparatus such as a touch panel. Alternatively, for example, the user terminal 40 displays, on the display apparatus, an image (such as a map) representing a store in which a recommended product is sold. This enables e user to obtain information that is suitable for a characteristic of the user. For example, the present system enables the user who has a pollen allergy to know a path that is less influenced by pollen and a product that is suitable to prepare for pollen.

### <Effect of the Present Example Embodiment>

An action pattern of a user is determined on the basis of various factors. However, in a case where a service to be provided to the user is to be optimized in accordance with a characteristic of the user and there is an error in estimation of the characteristic, it is impossible to provide a service that is desired by the user. This requires estimation of the characteristic of the user with high accuracy.

Conventionally, purchase information of the user is collected, and, for example, provision of a service that is in accordance with a purchase tendency of the user is carried out. In contrast, the analysis apparatus 30 according to the present example embodiment estimates a characteristic of a user, the characteristic causing a change in movement history of the user. Thus, the present example embodiment makes it possible to obtain an estimation result that cannot be obtained only by a tendency analysis obtained by collection of purchase information.

The analysis apparatus 30 according to the present example embodiment detects a change in movement path with reference to movement history information (information indicative of a history of a first action) of a user who is a provision target, and estimates a characteristic of the user, the characteristic causing the detected change, with reference to purchase history information (information indicative of a second action) of the user and environment history information (information indicative of a history of an environment around the user). The analysis apparatus 30 also outputs recommendation information that is in accordance with the estimated characteristic of the user. Thus, the analysis apparatus 30 according to the present example embodiment makes it possible to present, to, for example, the user, the recommendation information that is in accordance with the characteristic of the user, the characteristic causing a change in movement path of the user.

The recommendation information that is output by the analysis apparatus 30 is, for example, a movement path which is suitable for the characteristic of the user. Thus, in a case where the analysis apparatus 30 presents the movement path which is suitable for the characteristic of the user, it is possible to understand the movement path that is suitable for the characteristic of the user. This allows the user to easily access a facility in the management target area 2. Furthermore, it is possible to, for example, contribute to achievement of Goal 11 “Sustainable Cities and Communities (provide universal access to safe, inclusive and accessible public spaces for persons)” of Sustainable Development Goals (SDGs).

### <Variation>

The above-described example embodiment has discussed a case where the first action of the user is movement of the user. The first action of the user is not limited to the first action that is shown in the above-described example embodiment. The first action of the user may be, for example, wearing sunglasses or using a parasol. In this case, it may be determined, by, for example, providing at least one camera in the management target area 2 so that the analysis apparatus 30 analyzes an image(s) captured by the at least one camera, whether the user is wearing sunglasses or whether the user is using a parasol. In this case, for example, when the user who is not wearing sunglasses carries out an operation to wear the sunglasses, the analysis apparatus 30 detects such a change in operation. Alternatively, for example, when the user who is not under a parasol carries out an operation to put up the parasol, the analysis apparatus 30 detects such a change in operation.

The above-described example embodiment also has discussed a case where the second action of the user is purchase of a product by the user. The second action of the user is not limited to the second action that is shown in the above-described example embodiment. The second action of the user may be, for example, having a medical examination at, for example, a hospital, or use of a gym.

In the above-described example embodiment, the estimation section 33 estimates the characteristic of the user with reference to both the information indicative of the history of the second action and the environment history information. The estimation section 33 may estimate the characteristic of the user with reference to the information indicative of the history of the second action or the environment history information.

The above-described example embodiment has discussed a case where the characteristic of the user indicates a tendency for the user to dislike a predetermined event, and the output section 34 outputs the recommendation information for avoiding an event that is disliked by the user (a cause of avoidance). Specification of the user and the recommendation information are not limited to those shown in the above-described example embodiment. Specification of the user may indicate a tendency (preference tendency) for the user to like a predetermined event, and the recommendation information may be information that matches the preference tendency of the user. For example, the estimation section 33 may estimate a characteristic of “like getting suntanned” as the characteristic of the user whose purchase history information includes information indicative of purchase of a tanning cream, and the output section 34 may output the recommendation information indicative of a less shady movement path.

In the above-described example embodiment, upon receiving the request for provision of the recommendation information from the user terminal 40, the analysis apparatus 30 carries out the recommendation information providing method S100 so as to output the recommendation information. A trigger for the analysis apparatus 30 to output the recommendation information is not limited to the trigger shown in the above-described example embodiment. The analysis apparatus 30 may output the recommendation information at a predetermined timing (e.g., once a day or the like).

Furthermore, for example, the analysis apparatus 30 may determine, on the basis of the position information of the user terminal 40, whether the user who is the provision target is to use a different path from the movement path indicated by the recommendation information, and may transmit the recommendation information to the user terminal 40 in a case where the user is to use the different path.

Moreover, for example, the analysis apparatus 30 may determine whether the user carries out a measure corresponding to the characteristic, and may vary, depending on whether the user carries out the measure, the recommendation information to be output. For example, the analysis apparatus 30 determines, on the basis of the purchase history information of the user, whether or the user carries out the measure corresponding to the characteristic. In a case where the user has purchased a product with which the characteristic of the user is associated, the analysis apparatus 30 determines that the user carries out the measure. In a case where the user carries out no measure, the analysis apparatus 30 sets a degree of influence of the characteristic as “1” and recommends a movement path that passes through only indoors. In contrast, in a case where the user carries out the measure, the analysis apparatus 30 sets the degree of influence as “0.5” and recommends a movement path that passes through outdoors in a partial section thereof.

### Third Example Embodiment

The following description will discuss a third example embodiment of the present invention in detail with reference to the drawings. Note that members having functions identical to those of the respective members described in the first and second example embodiments are given respective identical reference numerals, and a description of those members is not repeated.

In the present example embodiment, an analysis apparatus 30 carries out the recommendation information providing method S100 illustrated in FIG. 5 in the above-described second example embodiment. Furthermore, in the recommendation information providing method S100 of FIG. 5, a estimation section 33 of the analysis apparatus 30 accumulates, in a storage apparatus of the analysis apparatus 30, information indicative of a characteristic of a user, the characteristic having been estimated in the step S107. In a case where the estimation section 33 estimates the characteristic of the user for a plurality of users and at a plurality of timings, the storage apparatus of the analysis apparatus 30 accumulates information indicative of the characteristic of the user for each of the plurality of users. In other words, in the present example embodiment, at least one user characteristic is associated in advance with each of the plurality of users.

FIG. 8 is a flowchart showing a flow of a second recommendation information providing method S200 carried out by the analysis apparatus 30. For example, upon receiving a request for provision of recommendation information from a user terminal 40, the analysis apparatus 30 may start the second recommendation information providing method S200. Alternatively, for example, at a predetermined timing (e.g., once a day or the like), the analysis apparatus 30 may start the second recommendation information providing method S200.

### (Step S201)

In a step S201, the estimation section 33 of the analysis apparatus 30 integrates information indicative of characteristics of a plurality of users, the characteristics being stored in the storage apparatus. As described earlier, in the present example embodiment, at least one characteristic is associated in advance with each of the plurality of users. The estimation section 33 aggregates the characteristics of the plurality of users and specifies, from among the plurality of characteristics, a characteristic that satisfies a predetermined condition. The predetermined condition is, for example, a condition that an appearance frequency is the highest or that the appearance frequency is higher than a threshold.

### (Step S202)

In a step S202, the output section 34 outputs the recommendation information is based on the that characteristics of the users, the characteristics having been aggregated by the estimation section 33 in the step S201. Examples of the recommendation information include route information indicative of a pattern of transfer of transportation such as a train, route information indicative of the shortest route, and route information indicative of a route with fewer transfers. Furthermore, for example, the recommendation information may be, for example, route information indicative of a movement path which is among a plurality of movement paths corresponding to a user who is a provision target and in the middle of which a store corresponding to a characteristic of the user is present (e.g., a movement path along which there is a bookstore at a transfer station).

### Effect of the Present Example Embodiment

According to the present example embodiment, the estimation section 33 aggregates a plurality of characteristics of a user and outputs recommendation information on the basis of a result obtained by aggregating the plurality of characteristics. This enables the analysis apparatus 30 to present, to the user, recommendation information that is more accurately suitable for the characteristics of the user.

### <Variation>

In the above-described example e embodiment, the analysis apparatus 30 outputs the recommendation information to the user terminal 40. Note, however, a destination to which the recommendation information is output is not limited to the user terminal 40 and may be another apparatus. The analysis apparatus 30 may output the recommendation information to, for example, a terminal that is used by a manager who manages, for example, the management target area 2. For example, in a case where an information recipient is the manager and a result obtained by aggregating a plurality of user characteristics is a characteristic of “dislike getting suntanned”, the recommendation information may be, for example, information that recommends a change in movement path.

### Fourth Example Embodiment

The following description will discuss a fourth example embodiment of the present invention in detail with reference to the drawings. Note that members having functions identical to those of the respective members described in the above-described first to third example embodiments are given respective identical reference numerals, and a description of those members is not repeated.

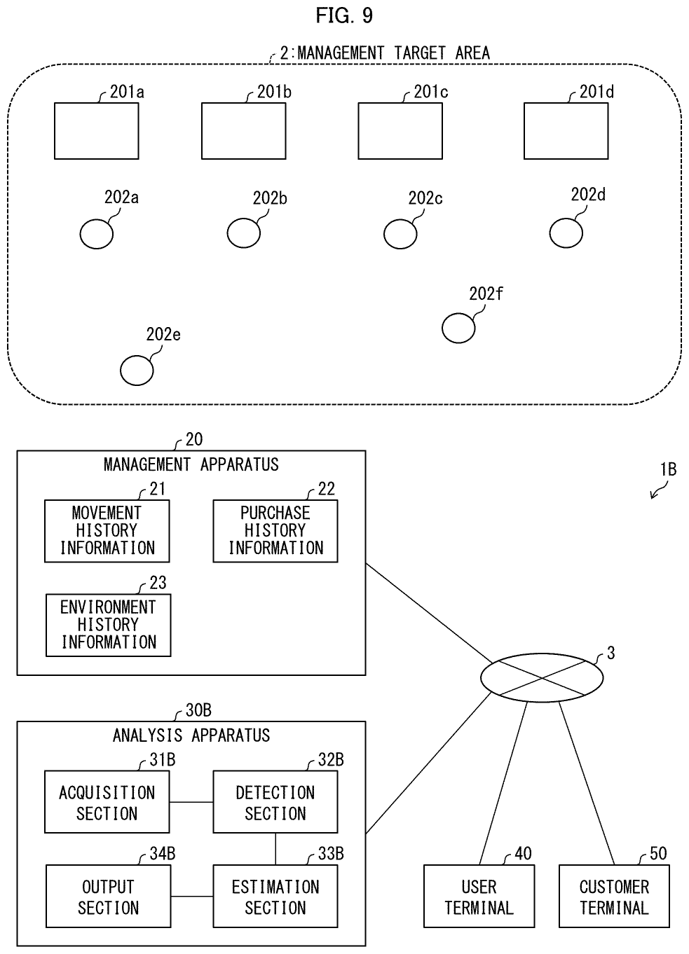

FIG. 9 is a diagram schematically illustrating a configuration of a recommendation information providing system 1B according to the present example embodiment. The recommendation information providing system 1B not only includes an analysis apparatus 30B with which the analysis apparatus 30 of the recommendation information providing system 1 of the above-described second example embodiment is replaced, but also includes a customer terminal 50.

The analysis apparatus 30B includes an acquisition section 31B, a detection section 32B, an estimation section 33B, and an output section 34B. The acquisition section 31B acquires information pertaining to a plurality of users. In the present example embodiment, the acquisition section 31B acquires information particularly pertaining to a plurality of users who used a predetermined service or a predetermined area. The detection section 32B further detects occurrence of an event that is based on a change in a first action, the change being caused by some or all of the plurality of users. The event that is based on the change in the first action is, for example, a decrease in number of persons staying in the predetermined area.

The estimation section 33B estimates, as a cause of occurrence of the event, information obtained by aggregating characteristics of the plurality of users, the characteristics being estimated for each of the plurality of users. The output section 34B outputs recommendation information that is in accordance with information obtained by aggregating the characteristics of the users for which the change has been detected. In the present example embodiment, the output section 34B outputs, in particular, the recommendation information to the customer terminal 50 that is used by a manager for the above-described service or the above-described area.

The customer terminal 50 is a terminal that is used by the manager for the above-described service or the above-described area, and is, for example, a personal computer, a tablet terminal, or a smartphone.

Also in the present example embodiment, the analysis apparatus 30B carries out the recommendation information providing method S100 illustrated in FIG. 5 in the above-described second example embodiment. Furthermore, in the recommendation information providing method S100 of FIG. 5, as in the case of the above-described third example embodiment, the estimation section 33 of the analysis apparatus 30 accumulates, in a storage apparatus of the analysis apparatus 30, information indicative of a characteristic of a user, the characteristic having been estimated in the step S107. In a case where the estimation section 33 estimates the characteristic of the user for a plurality of users and at a plurality of timings, the storage apparatus of the analysis apparatus 30 accumulates information indicative of the characteristic of the user for each of the plurality of users. In other words, in the present example embodiment, at least one user characteristic is associated in advance with each of the plurality of users.

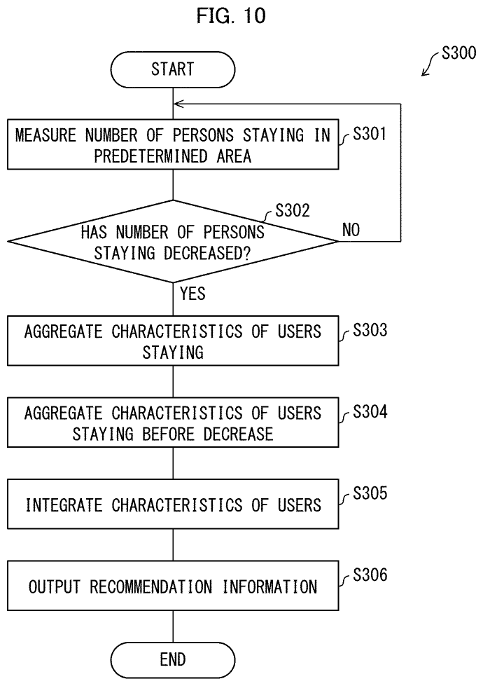

FIG. 10 is a flowchart showing a flow of a third recommendation information providing method S300 carried out by the analysis apparatus 30B. Note that some of steps included in the third recommendation information providing method S300 may be carried out in parallel or in a different order. For example, upon receiving a request for provision of the recommendation information from a management apparatus 20, the analysis apparatus 30 starts the third recommendation information providing method S300.

### (Step S301)

In a step S301, the detection section 32B measures the number of persons staying in a predetermined area. The predetermined area is, for example, some or all area of a management target area. For example, the detection section 32B may measure, on the basis of information indicative of a position of the user terminal 40, the number of persons staying. In the storage apparatus, the detection section 32B stores, together with time information, the number of persons staying in the predetermined area.

The detection section 32B also specifies a user ID that identifies a user staying in the above-described area, and accumulates, in the storage apparatus, the specified user ID together with the time information. For example, the detection section 32B specifies the user ID by acquiring, from the user terminal 40, the user ID or identification information (e.g., a terminal ID) associated with the user ID. The information (user ID) that has been specified by the detection section 32B and that identifies the user staying in the above-described area is referred to by the estimation section 33B in later-stage steps S303 and S304.

### (Step S302)

In a step S302, the detection section 32B determines whether the number of persons staying in the predetermined area has decreased. A decrease in number of persons staying in the predetermined area is an example of the “event that is based on the change in the first action” according to the present specification. For example, the detection section 32B compares the current number of users staying in the predetermined area with the number of users who were staying in the predetermined area a certain time ago, and determines, in a case where a rate of decrease exceeds a predetermined threshold, that the number of persons staying has decreased. A method for determining whether the number of persons staying has decreased is not limited to the above-described method and may be another method. For example, the detection section 32B may determine, in a case where the number of persons staying in the above-described area falls below a threshold, that the number of persons staying has decreased.

In a case where the number of persons staying has decreased (YES in the step S302), the detection section 32B proceeds to the process in the step S303. In contrast, in a case where the number of persons staying has not decreased (NO in the step S302), the detection section 32B returns to the process in the step S301.

### (Step S303)

In the step S303, the estimation section 33B aggregates characteristics of the users who are currently staying in the predetermined area. More specifically, the estimation section 33B reads, from the storage apparatus, information indicative of characteristics of users corresponding to user IDs of the users who are staying in the above-described area, and aggregates the information.

### (Step S304)

In the step S304, the estimation section 33B aggregates the characteristics of the users who were staying in the predetermined area before the decrease. More specifically, the estimation section 33B reads, from the storage apparatus, information indicative of characteristics of users corresponding to user IDs of the users who were staying in the above-described area before the decrease, and aggregates the information.

### (Step S305)

In a step S305, on the basis of a comparison between a result of aggregation in the step S303 and a result of aggregation in the step S304, the estimation section 33B aggregates user characteristics estimated for each of the plurality of users who moved from the above-described area to another area. As described earlier, in the present example embodiment, at least one characteristic is associated in advance with each of the plurality of users. The estimation section 33B aggregates characteristics of users who moved to outside the above-described area, and specifies, from among a plurality of characteristics, a characteristic that satisfies a predetermined condition. The predetermined condition is, for example, a condition that the number of associated users is the greatest or that the number of associated users is greater than a threshold.

### (Step S306)

In a step S306, the estimation section 33B outputs the recommendation information that is in accordance with information obtained by aggregating the user characteristics. In the present example embodiment, the recommendation information is information indicative of, for example, a matter or a product that is recommended to a manager for a service or an area. For example, in a case where a user characteristic specified in the step S305 is “dislike getting suntanned”, a decrease in number of persons staying in the above-described area is considered to be mainly due to a user who wishes to avoid suntan. In this case, the recommendation information is, for example, information that recommends “installing a roof for sun shading”. For example, in a case where the user characteristic specified in the step S305 is “dislike too strong air conditioning”, the decrease in number of persons staying in the above-described area is considered to be due to too strong air conditioning. In this case, the recommendation information is, for example, information that recommends “increasing temperature of air conditioning”.

The customer terminal 50 receives the recommendation information from the analysis apparatus 30B and presents the received recommendation information to the manager by, for example, displaying the recommendation information on a display apparatus. This enables the manager to obtain information suitable for a characteristic of a user who uses the service or the area that is to be managed. With this, for example, the manager can obtain information for overcoming a cause (e.g., intense sunlight or the like) of the decrease in number of persons staying in the predetermined area.

### Effect of the Present Example Embodiment

As described above, according to the present example embodiment, in a case where the number of persons staying in a predetermined area has decreased, the analysis apparatus 30B carries out a tendency analysis by collecting characteristics of users who are staying in the area and characteristics of users who were staying in the area. This enables a manager to understand not only information on the number of persons decreased but also a cause of a decrease in number of persons.

In a case where the analysis apparatus 30B presents, to the manager, recommendation information that is in accordance with a user characteristic, the manager can improve an environment of a facility in a management target area 2 in accordance with a characteristic of a user who uses the management target area 2. This allows the user to easily access the facility in the management target area 2. This makes it possible to, for example, contribute to achievement of Goal 11 “Sustainable Cities and Communities (provide universal access to safe, inclusive and accessible public spaces for persons)” of Sustainable Development Goals (SDGs).

### <Variation>

In the above-described example embodiment, the detection section 32B detected a decrease in number of users staying in a predetermined area (the step S302 of FIG. 10). However, an event that is detected by the detection section 32B is not limited to the event shown in the above-described embodiment. Occurrence of an event that is detected by the detection section 32B and that is based on a change in first action of a user may be occurrence of another event. For example, the detection section 32B may calculate the number of persons staying for each user characteristic in a predetermined area, and may carry out, in response to the fact that an amount of change in number of persons staying for each characteristic has fallen below a predetermined threshold, a process for outputting recommendation information.

### Software Implementation Example

Some or all of functions of the information processing apparatus 10, the management apparatus 20, the analysis apparatuses 30 and 30B, the user terminal 40, and the customer terminal 50 (hereinafter referred to as “information processing apparatus 10, etc.”) can be realized by hardware such as an integrated circuit (IC chip) or the like or can be alternatively realized by software.

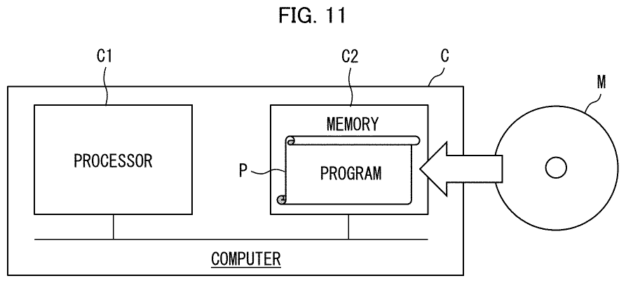

In the latter case, the information processing apparatus 10, etc. are each realized by, for example, a computer that executes instructions of a program that is software realizing the functions. FIG. 11 illustrates an example of such a computer (hereinafter referred to as “computer C”). The computer C includes at least one processor C1 and at least one memory C2. The memory C2 stores a program P for causing the computer C to operate as the information processing apparatus 10, etc. In the computer C, the processor C1 reads and executes the program P stored in the memory C2, so that the functions of the information processing apparatus 10, etc. are realized.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via the transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can also be described as below. Note, however, that the present invention is not limited to the following supplementary notes.

### Supplementary Note 1

An information processing apparatus including:
an acquisition means that acquires information indicative of a history of a first action of a user and one or both of information indicative of a history of a second action of the user, the second action being different from the first action, and information indicative of a history of an environment around the user;
a detection means that detects a change in the first action with reference to the information indicative of the history of the first action; and an estimation means that estimates, with reference to one or both of the information indicative of the history of the second action and the information indicative of the history of the environment, a characteristic of the user, the characteristic causing the change.

The above configuration enables the information processing apparatus to accurately estimate a characteristic of a user, the characteristic causing a change in action of the user.

### Supplementary Note 2

The information processing apparatus according to Supplementary note 1, wherein
the first action includes movement of the user, and
the detection means detects, as the change, a change in region in which the user stays or a change in movement path.

The above configuration enables the information processing apparatus to accurately estimate a characteristic of a user, the characteristic causing a change in region in which the user stays or a change in movement path.

### Supplementary Note 3

The information processing apparatus according to Supplementary note 1 or 2, wherein the second action includes purchase of a product by the user, and the estimation means estimates the characteristic of the user with reference to the product purchased by the user.

The above configuration enables the information processing apparatus to accurately estimate a characteristic of a user, the characteristic causing a change in action of the user.

### Supplementary Note 4

The information processing apparatus according to any one of Supplementary notes 1 to 3, wherein the estimation means estimates, as the characteristic of the user, a tendency for the user to avoid an event that is avoidable by the change.

The above configuration enables the information processing apparatus to accurately estimate a tendency for a user to avoid an event that is avoidable by the change, the tendency causing a change in action of the user.

### Supplementary Note 5

The information processing apparatus according to any one of Supplementary notes 1 to 4, further including an output means that outputs recommendation information which is in accordance with the characteristic of the user.

The above configuration enables the information processing apparatus to present, to, for example, a user, recommendation information that is in accordance with a characteristic of the user, the characteristic causing a change in action of the user.

### Supplementary Note 6

The information processing apparatus according to Supplementary note 5, wherein the output means outputs the recommendation information to a terminal that is used by the user.

The above configuration information processing apparatus to present, to a user, a characteristic of the user, the characteristic causing a change in action of the user.

### Supplementary Note 7

The information processing apparatus according to Supplementary note 5, wherein
the acquisition means acquires the information pertaining to a plurality of users,
the detection means detects a change in the first action for each of some or all of the plurality of users,
the estimation means estimates characteristics of the user for users for which the change has been detected, and
the output means outputs the recommendation information that is in accordance with information obtained by aggregating the characteristics of the users for which the change has been detected.

The above configuration enables the information processing apparatus to present, to, for example, a user, recommendation information that is in accordance with information obtained by aggregating characteristics of a plurality of users. This enables the user to obtain recommendation information that is in accordance with a tendency of a characteristic of the user.

### Supplementary Note 8

The information processing apparatus according to Supplementary note 7, wherein the acquisition means acquires the information pertaining to the plurality of users who used a predetermined service or a predetermined area, and the output means outputs the recommendation information to a terminal that is used by a manager for the predetermined service or the predetermined area.

The above configuration enables the information processing apparatus to present, to, a manager for a predetermined service or a predetermined area, recommendation information that is in accordance with a characteristic of a user who used the predetermined service or the predetermined area, the characteristic causing a change in action of the user. As a result, by checking the recommendation information, the manager can take, in accordance with such a characteristic of the user, measures to prevent a change in action of the user or to change the action of the user.

### Supplementary Note 9

An information processing method including:
(a) acquiring information indicative of a history of a first action of a user and one or both of information indicative of a history of a second action of the user, the second action being different from the first action, and information indicative of a history of an environment around the user;
(b) detecting a change in the first action with reference to the information indicative of the history of the first action; and
(c) estimating, with reference to one or both of the information indicative of the history of the second action and the information indicative of the history of the environment, a characteristic of the user, the characteristic causing the change,
(a) to (c) each being carried out by the information processing apparatus.

The above configuration enables the information processing apparatus to accurately estimate a characteristic of a user, the characteristic causing a change in action of the user.

### Supplementary Note 10

A program for causing a computer to function as an information processing apparatus, the program causing the computer to function as:
an acquisition means that acquires information indicative of a history of a first action of a user and one or both of information indicative of a history of a second action of the user, the second action being different from the first action, and information indicative of a history of an environment around the user;
a detection means that detects a change in the first action with reference to the information indicative of the history of the first action; and
an estimation means that estimates, with reference to one or both of the information indicative of the history of the second action and the information indicative of the history of the environment, a characteristic of the user, the characteristic causing the change.

### Additional Remark 3

The whole or part of the example embodiments disclosed above can also be expressed as follows.

An information processing apparatus including at least one processor, the at least one processor carrying out:
an acquisition process for acquiring information indicative of a history of a first action of a user and one or both of information indicative of a history of a second action of the user, the second action being different from the first action, and information indicative of a history of an environment around the user;
a detection process for detecting a change in the first action with reference to the information indicative of the history of the first action; and
an estimation process for estimating, with reference to one or both of the information indicative of the history of the second action and the information indicative of the history of the environment, a characteristic of the user, the characteristic causing the change.

Note that the information processing apparatus may further include a memory, which may store a program for causing the at least one processor to carry out the acquisition process, the detection process, and the estimation process. The program may be stored in a non-transitory tangible computer-readable storage medium.

### REFERENCE SIGNS LIST

1 System
2 Management target area
10 Information processing apparatus
11, 31 Acquisition section (acquisition means)
12, 32 Detection section (detection means)
13, 33, 33B Estimation section (estimation means)
20 Management apparatus
30, 30B Analysis apparatus
34, 34B Output section
40 User terminal
50 Customer terminal
201a, 201b, 201c, 201d Building
202a, 202b, 202c, 202d, 202e, 202f Sensor

What is claimed is:

1. An information processing apparatus comprising at least one processor, the at least one processor carrying out:
an acquisition process for acquiring history information including information indicative of a history of a first action of a user and one or both of information indicative of a history of a second action of the user, the second action being different from the first action, and information indicative of a history of an environment around the user;
a detection process for detecting a change in the first action with reference to the information indicative of the history of the first action; and
an estimation process for estimating, with reference to one or both of the information indicative of the history of the second action and the information indicative of the history of the environment, a characteristic of the user, the characteristic causing the change.

2. The information processing apparatus according to claim 1, wherein
the first action includes movement of the user, and
in the detection process, the at least one processor detects, as the change, a change in region in which the user stays or a change in movement path.

3. The information processing apparatus according to claim 1, wherein
the second action includes purchase of a product by the user, and
in the estimation process, the at least one processor estimates the characteristic of the user with reference to the product purchased by the user.

4. The information processing apparatus according to claim 1, wherein in the estimation process, the at least one processor estimates, as the characteristic of the user, a tendency for the user to avoid an event that is avoidable by the change.

5. The information processing apparatus according to claim 1, wherein the at least one processor further carries out an output process for outputting recommendation information which is in accordance with the characteristic of the user.

6. The information processing apparatus according to claim 5, wherein in the output process, the at least one processor outputs the recommendation information to a terminal that is used by the user.

7. The information processing apparatus according to claim 5, wherein
in the acquisition process, the at least one processor acquires the history information pertaining to a plurality of users,
in the detection process, the at least one processor further detects occurrence of an event that is based on at least one change in the first action which is caused by some or all of the plurality of users,
in the estimation process, the at least one processor estimates, as a cause of occurrence of the event, information obtained by aggregating characteristics estimated for the plurality of users, and
in the output process, the at least one processor outputs the recommendation information that is in accordance with the information obtained by aggregating the characteristics of the plurality of users.

8. The information processing apparatus according to claim 7, wherein
in the acquisition process, the at least one processor acquires the information pertaining to the plurality of users who used a predetermined service or a predetermined area, and
in the output process, the at least one processor outputs the recommendation information to a terminal that is used by a manager for the predetermined service or the predetermined area.

9. An information processing method comprising:
(a) acquiring history information including information indicative of a history of a first action of a user and one or both of information indicative of a history of a second action of the user, the second action being different from the first action, and information indicative of a history of an environment around the user;
(b) detecting a change in the first action with reference to the information indicative of the history of the first action; and
(c) estimating, with reference to one or both of the information indicative of the history of the second action and the information indicative of the history of the environment, a characteristic of the user, the characteristic causing the change,
(a) to (c) each being carried out by the information processing apparatus.

10. A non-transitory storage medium storing therein a program for causing a computer to function as an information processing apparatus, the program causing the computer to carry out:
an acquisition process for acquiring history information including information indicative of a history of a first action of a user and one or both of information indicative of a history of a second action of the user, the second action being different from the first action, and information indicative of a history of an environment around the user;
a detection process for detecting a change in the first action with reference to the information indicative of the history of the first action; and
an estimation process for estimating, with reference to one or both of the information indicative of the history of the second action and the information indicative of the history of the environment, a characteristic of the user, the characteristic causing the change.
